(19) United States
(12) Patent Application Publication
(10) Pub. No.: US 2006/0167929 A1
(43) Pub. Date: Jul. 27, 2006

(54) Method for optimizing archival of XML documents

(76) Inventors: Amit Chakraborty, Cranbury, NJ (US); Liang H. Hsu, Irvine, NJ (US)

Correspondence Address: Siemens Corporation, Intellectual Property Department, 170 Wood Avenue South, Iselin, NJ, 08830, US

(21) Appl. No.: 11/208,810

(22) Filed: Aug. 22, 2005

Related U.S. Application Data
(60) Provisional application No. 60/646,785, filed on Jan. 25, 2005.
(60) Provisional application No. 60/646,851, filed on Jan. 25, 2005.

(51) Int. Cl. G06F 7/00

(52) U.S. Cl. 707/102

(57) ABSTRACT

A technique for optimizing the archiving and management of data stored as XML documents is capable of handling mixed data including highly structured data and unstructured data. The technique maps the structured data to a relational database while storing the unstructured data in its native XML format. The data is updated using a rules database that maps updating rules against attributes and classes of elements within the documents. A document checking/validation engine performs the updates based on rule verification.

### CLAIM OF PRIORITY

This application claims priority to, and incorporates by reference herein in its entirety, pending U.S. Provisional Patent Application Serial No. 60/646,785, filed Jan. 25, 2005, and pending U.S. Provisional Patent Application Ser. No. 60/646,851, also filed Jan. 25, 2005.

### FIELD OF THE INVENTION

The present invention relates generally to the fields of document management and database management. More specifically, the invention relates to the management of XML documents having varying structures and definitions.

### BACKGROUND OF THE INVENTION

With the rapid spread of the World Wide Web, many business processes and information dissemination both within and outside organizations have either moved to the Web or have expanded into it. The new mode of data collection, document creation and movement is via the XML (eXchange Markup Language) format. With that, however, comes the question of the effective maintenance and retrieval of that data.

The exponential increase in Internet usage has ushered in a boom in electronic business activities around the globe. Every day numerous organizations, some new and some old, are creating hundreds of thousands of Web pages touting their services and products. Moreover, an e-marketplace has emerged where transactions between different organizations and between the individual customer and a collection of business partners are taking place seamlessly. All of that has been facilitated by the power of the Web, which in turn is now based largely on XML. XML is being used as the standard mode of document exchange on the Web. The popularization of that standard has not only helped in the integration process and communication between organizations, but has facilitated in-house integration as well. The inherent structural richness that is the hallmark of the XML language has helped with the document management process.

However, to be able to fully exploit the advantages that come with this, one must be able to archive and search profitably such documents, and search in a manner that takes advantage of the structured nature of such documents. That is especially true for the case of ebusiness applications where different products might have to be searched based on their different characteristics, or based on their hierarchical position. One example of such an application is a group of XML documents describing spare parts.

As to the retrieval of data stored as XML documents, there are two commonly-used search philosophies: one that directly searches the XML databases as a collection of files and the other that first maps the XML data to a relational database and then searches that database. The effectiveness of each of those techniques depends largely on the type of data encountered.

It is common knowledge that relational databases are highly efficient for the archival and querying of data that can be tabularized. XML data doesn't necessarily follow a tabularized structure; rather, the strength of the XML representation comes from its hierarchical structured representation. XML data might or might not follow a Document Type Definition (DTD) or a schema.

An XML document is itself a database only in the strictest sense of the term since it is simply a collection of data. It has its advantage in the sense that it is portable and that it can describe data in a tree or graph structure. But in the broader sense of the term, XML documents don't quite represent a database as there are no underlying database management systems that can capture and control the data. While XML technology comes with schemas or DTDs that describe the data, query languages such as Structured Query Language (XQL) and programming interfaces such as the Document Object Model (DOM) still lack the main features of a database, such as efficient storage, indexes, security, transactions and data integrity, multi-user access, triggers, queries across multiple documents and so on. Thus, while it may be possible to use an XML document or documents as a database in environments with small amounts of data, few users and modest performance requirements, such a system will fail in most production environments that have multiple users, strict data integrity requirements and the need for good performance.

Mapping simple, well-formed XML data to a database is often very inefficient as there are no underlying rules that govern the structure of such information. In such cases it is better to use directly a native XML search strategy that doesn't try to make use of an underlying relational database. However, there might be document segments where the data normally follows a highly regularized structure defined by a DTD or a schema and can often be used by non-XML applications where a relational database approach might be more efficient.

It is frequently the case that documents contain data that is a mixture of highly regularized data and other contextual information that makes representation more complicated simply by mapping to a relational database, The highly regularized data is often easily be represented by table. The contextual information, on the other hand, may make use of such mechanisms as entities and other XML features that make direct representation by a relational database inefficient, both in terms of space (by resulting in a number of empty or at best sparsely populated tables) and search time. It is also frequently important to know whether a document collection merit a tabular description or whether such data should be stored in a tabular fashion.

The above-mentioned rise in the use of XML as a data storage mechanism on the Web also raises the question of effective management of that data. As the volume of documents grows it becomes impossible for any human to keep track of the documents and take appropriate action, to update, delete or replace them.

Managing large numbers of documents is quite non-trivial. It is important to assure that documents are maintained and updated on a regular basis such as monthly or semi-yearly. Manual hit-or-miss approaches, however, are severely limited when the number of documents in the collection grows. Even if such approaches work, they are likely to result in a lot of wasted effort reviewing a many documents that don't need updating.

For a system to be capable of managing a large number of documents, a large amount of knowledge must be built into the system in terms of rules that can either be a given or learned through observation. Documents then must be associated with those rules that will trigger a change request to the document owner at the appropriate times.

Further, to assure that a document update is indeed appropriate (or for that matter that a new document meets the existing requirements), further rules must be established. Even without understanding the meaning of a document, one can use information theoretic methods in combination with appropriate rules to measure the information content of a document to determine whether updating is appropriate.

There is therefore presently a need to provide methods and systems for management of large data archives containing XML files. Particularly, there is a need for a technique for managing document updating in such a system, and to optimize searching. To the inventors' knowledge, no such techniques are currently available.

### SUMMARY OF THE INVENTION

The present invention addresses the needs described above by providing a method for managing mark-up language documents. In one embodiment of the invention, the method includes the steps of classifying the documents into classes, determining a degree of repeatability of elements contained in the class, and, based at least in part on the degree of repeatability of the elements, mapping more repeatable elements to an archiving relational database and archiving less repeatable elements as mark-up language document data to create a hybrid database. The hybrid database is populated with the markup language documents.

A table schema is created, capturing a structure of the hybrid database. The table schema is mapped to a rules database, and the rules database is populated with rules for updating the elements of the hybrid database, the populated rules database representing conditional relationships among the rules. In a checking/validation engine, the elements of the hybrid database are updated according to the rules.

The step of classifying the documents into classes may further include the step of analyzing a tree structure of at least one DTD defining the documents. In that case, the step of classifying the documents into classes may further include the steps of selecting a test set of documents representative of the mark-up language documents, training a learning network using the test set, classifying a remainder of the mark-up language documents using the trained learning network, and repeating the selecting, training and classifying steps to improve the classification.

For each class, the method may include the step of identifying important sub-trees of the class based on sub-tree size, and the step of determining a degree of repeatability of elements contained in the classes may further comprise determining that a node not in an important sub-tree is one of said less repeatable elements.

In that method, the step of determining a degree of repeatability of elements contained in the class may further include, for each important sub-tree, the steps of associating those elements of the sub-tree having children, with a class, if one of said elements having children is of type PCDATA, associating a terminal string variable with it, and, if an element is repeatable, associating an array with it.

Further in that method, the step of mapping more repeatable elements to the archiving relational database and archiving less repeatable elements as mark-up language document data to create a hybrid database may further include, for each said class associated with a sub-tree having children, the steps of associating a table with the class unless the class represents a table subpart, defining a foreign key from each child that is in itself a class, defining a primary key from each class that is a child of another class, mapping all said string classes to columns, mapping all classes that are table rows to simple rows, and mapping all classes that are arrays to a table.

The step of populating the hybrid database with the markup language documents may further include, for each mark-up language document, the steps of creating a document object model (DOM) representation, for each node of the DOM representing an element to be mapped to a table in the archiving relational database, disconnecting the node and creating a reference to said table, and populating tables in the archiving relational database with data in the disconnected node.

The step of creating a table schema capturing a structure of the hybrid database may further include the steps of creating attributes for triggering rules and for linking hierarchies in the table schema, creating the table schema, wherein end nodes of said table schema are the mark-up language documents, associating classes with all elements, and encoding class relationships using primary and foreign keys.

The step of populating the rules database with rules for updating the elements of the hybrid database may comprise the steps of identifying all high level rules, identifying conditional rules and associated parent rules, associating document attributes with high level rules and conditional rules to which the attributes apply, identifying classes against which said high level and conditional rules apply, and populating the rules database with rules and relationships of the rules with other rules, documents attributes and document classes.

The step of updating the elements of the hybrid database according to the rules may include the steps of triggering a document update of a subject document according to a rule, checking whether the subject document exists, and if not, determining that an update is necessary, computing document content information of the subject document, using the computed document content information, checking whether the subject document is current according to the rule, and if not, determining that an update is necessary, and, if an update is necessary, transmitting a notification to a document owner.

In that case, the step of computing document content information may comprise computing a number of nodes of the document. Further, the step of computing document content information may include using an information theoretic technique of measuring intrinsic variation in the document.

### BRIEF DESCRIPTION OF THE DRAWINGS

FIG. 1 is a schematic diagram showing a technique for archiving XML documents in accordance with one embodiment of the invention.

FIG. 2 is a flowchart showing a method for DTD analysis according to an embodiment of the invention.

FIG. 3 is an example DTD fragment used in explaining a method according to an embodiment of the invention.

FIG. 4 is a flowchart showing a method for node analysis according to an embodiment of the invention.

FIG. 5 is a flowchart showing a method for database population according to an embodiment of the invention.

FIGS. 6a & 6b comprise a flowchart showing a method for query formation according to an embodiment of the invention.

FIG. 7 is a schematic diagram showing a technique for updating XML documents in accordance with one embodiment of the invention.

FIG. 8 is a flowchart showing a method for DTD generation and database mapping for document updating according to an embodiment of the invention.

FIG. 9 is a flowchart showing a method for creating a rules database for document updating according to an embodiment of the invention.

FIG. 10 is a flowchart showing a method for checking and verifying documents according to an embodiment of the invention.

FIG. 11 is a schematic diagram of an exemplary computer system on which a system according to the invention may be deployed.

### DESCRIPTION OF THE INVENTION

In the following discussion, techniques are presented for optimizing processes pertaining to XML document archiving. The first such technique is a technique for archiving and querying in such a way as to optimize document searching and retrieval. An important aspect of that technique is determining in an optimal way whether a certain node as represented in the DTD should be tabularized or should be stored as an XML fragment. The second technique is a technique for managing document updating. The techniques are especially beneficial when used together.

The invention is a modular framework and method and is deployed as software as an application program tangibly embodied on a program storage device. The application is accessed through a graphical user interface (GUI). The application code for execution can reside on a plurality of different types of computer readable media known to those skilled in the art. Users access the framework by accessing the GUI via a computer.

An embodiment of a computer 21 executing the instructions of an embodiment of the invention is shown in FIG. 12. A representative hardware environment is depicted which illustrates a typical hardware configuration of a computer. The computer 21 includes a CPU 23, memory 25, a reader 27 for reading computer executable instructions on computer readable media, a common communication bus 29, a communication suite 31 with external ports 33, a network protocol suite 35 with external ports 37 and a GUI 39.

The communication bus 29 allows bi-directional communication between the components of the computer 21. The communication suite 31 and external ports 33 allow bi-directional communication between the computer 21, other computers 21, and external compatible devices such as laptop computers and the like using communication protocols such as IEEE 1394 (FireWire or i.LINK), IEEE 802.3 (Ethernet), RS (Recommended Standard) 232, 422, 423, USB (Universal Serial Bus) and others.

The network protocol suite 35 and external ports 37 allow for the physical network connection and collection of protocols when communicating over a network. Protocols such as TCP/IP (Transmission Control Protocol/Internet Protocol) suite, IPX/SPX (Internetwork Packet eXchange/Sequential Packet eXchange), SNA (Systems Network Architecture), and others. The TCP/IP suite includes IP (Internet Protocol), TCP (Transmission Control Protocol), ARP (Address Resolution Protocol), and HTTP (Hypertext Transfer Protocol). Each protocol within a network protocol suite has a specific function to support communication between computers coupled to a network. The GUI 39 includes a graphics display such as a CRT, fixed-pixel display or others 41, a key pad, keyboard or touchscreen 43 and pointing device 45 such as a mouse, trackball, optical pen or others to provide an easy-to-use, user interface for the invention.

The computer 21 can be a handheld device such as an Internet appliance, PDA (Personal Digital Assistant), Blackberry device or conventional personal computer such as a PC, Macintosh, or UNIX based workstation running their appropriate OS (Operating System) capable of communicating with a computer over wireline (guided) or wireless (unguided) communications media. The CPU 23 executes compatible instructions or software stored in the memory 25. Those skilled in the art will appreciate that the invention may also be practiced on platforms and operating systems other than those mentioned.

Optimizing XML Archiving

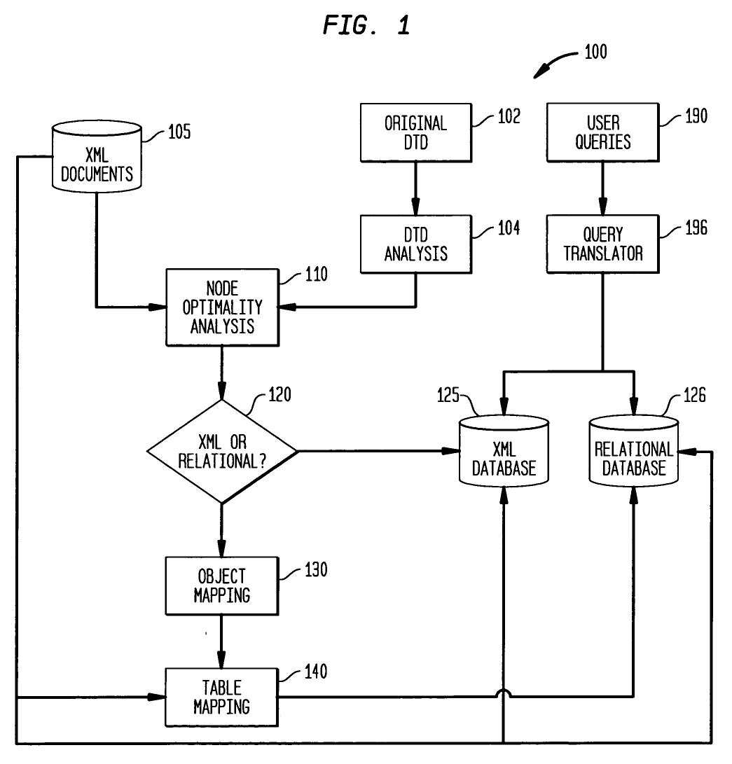

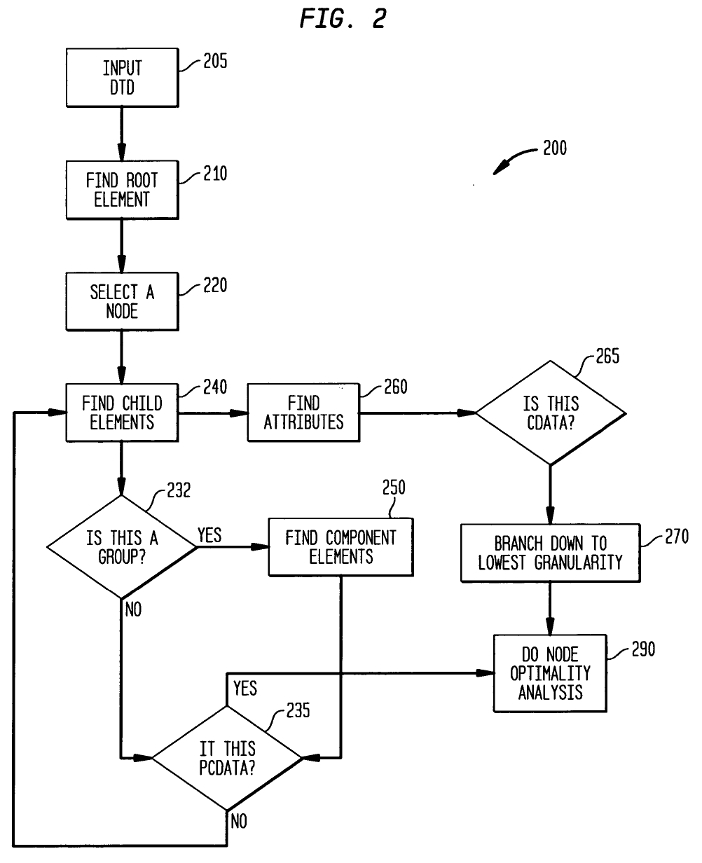

A schematic diagram showing the main steps in the inventive process of generating a database from a collection of XML files is shown in FIG. 1. The process includes five primary steps.

The first step 104 is an analysis of the DTD 102 or the schema that define the XML pages. For example, for the content in a catalog-type Web site, the DTD might describe product offerings. An analysis 104 of the original DTD 102 includes identifying the most important elements, attributes, subgroups. Parent-child relationships, sibling relationships, groupings, and nested hierarchies are observed and identified.

The DTD may be very generic, but the full scope of it is not necessary to characterize the class of documents under consideration. In order for the node optimality analysis 110 to optimize the database in terms of the number of tables and columns, not only is a DTD analysis 104 considered, but also representative XML documents 105 are considered to identify their scope.

The second step 110 is a node optimality analysis to identify those parts of the DTD that must be mapped to a relational database and identify others that will be left alone to be used by a native XML database 125. As a general rule, non-repeatable and non-tabular elements are not mapped to a relational database whereas tabular elements in particular are mapped to a relational database 126. [Amit, is this changed sentence now correct? This passage was taken from the bottom of page 4 of the 2005P01296 disclosure.]

An important aspect of the invention is the way that determination is made. At every step of the process an optimization is done based on the XML document collection 105 whether a certain sub-tree of the DTD or XML scheme merits a separate table.

A third overall step 130 is to design a collection of classes that serves as an intermediate step in the design process. These define the object schemas. They describe in clearer terms the relationship between different classes and the granularity of the underlying data.

The next overall step in the process is to map (step 140) the above classes to corresponding tables and further to identify the foreign and primary keys of the different tables. That effectively defines the database schema. In the table mapping step, it is important to assure that all available and likely documents are appropriately mapped, and that the relationships between the different tables are mapped properly enough for any XML query to be translated to a corresponding database query.

The final overall step 196 is to be able to map the queries 190 into a collection of steps that query the corresponding part of the system that holds the data (i.e., the XML database 125 or the relational database 126). In general, any query fetching a whole document or part of the underlying XML tree, can involve interfaces to both databases 125, 126.

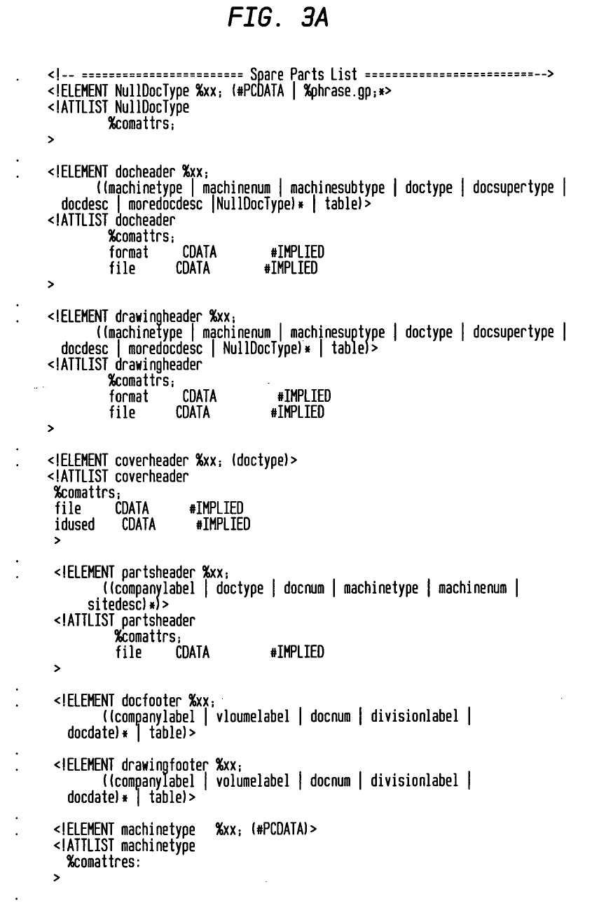

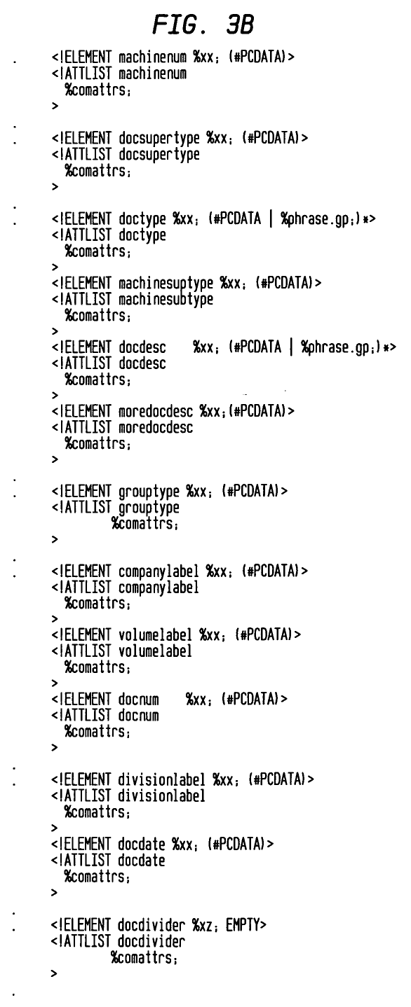

A more detailed explanation of the first step in the archiving process, represented by step 104 of FIG. 1, is now provided with reference to FIG. 2. That initial step of the archiving process is an analysis of the underlying DTD. An example fragment of an input DTD 210, used for a group of XML documents containing product descriptions of spare parts, is presented as FIG. 3. As can clearly be seen, the DTD includes an extensive body 310 of declarations and is clearly very generic. The primary purpose of the node optimality analysis step is to isolate segments of the DTD that need a mapping to a schema that can be used by a relational database.

In general, for those segments that are identified to be segments that should be mapped to a conventional database, the main elements and attributes are identified. Nested elements are also simplified to linearize the structure.

Referring again to FIG. 2, the steps included in the process are as follows: First, the root element of the input DTD 205 is identified (step 210). Next, for selected nodes of the root element (step 220), the children and attributes of the root element are identified (step 240 and examined. For each identified child element, it is determined whether it is of type PCDATA (step 235).

If the child element is not of type PCDATA, then all the child element(s) of that element are found (step 240). For each of those child elements, if it is not a group (step 232), then the element is examined to determine whether it is of type PCDATA (step 235). If the child element is a group, then the components of the group are identified (step 250) and it is determined whether those components are of type PCDATA (step 235). That loop is repeated until all elements are of type PCDATA.

For each child element found in step 240, all attributes are also identified (step 260). If the attributes are not of type CDATA (step 265), then the method continues to branch down to the lowest granularity (step 270).

The DTD is then examined to determine whether a sub-tree exists (step 290) at various locations. A node optimality analysis is then performed to determine whether it makes sense to create a tabular description for the underlying sub-tree.

The above steps simplify the DTD and identify the elements and attributes that are actually used and require mapping to the database schema. It must be remembered, however, that there are other segments of the DTD that are not mapped to the database, but are instead linked, and hence, to the user, the XML archiving system appears to be an integrated system.

Step 290 of the above process identifies which sub trees of the DTD are mapped to a relational database. If a similar sub-tree exists at different locations in the DTD, and if those sub-trees have an internal tabular structure, they can be mapped to a single table with a primary key that identifies the XML parent. Alternatively, they can be mapped to different tables.

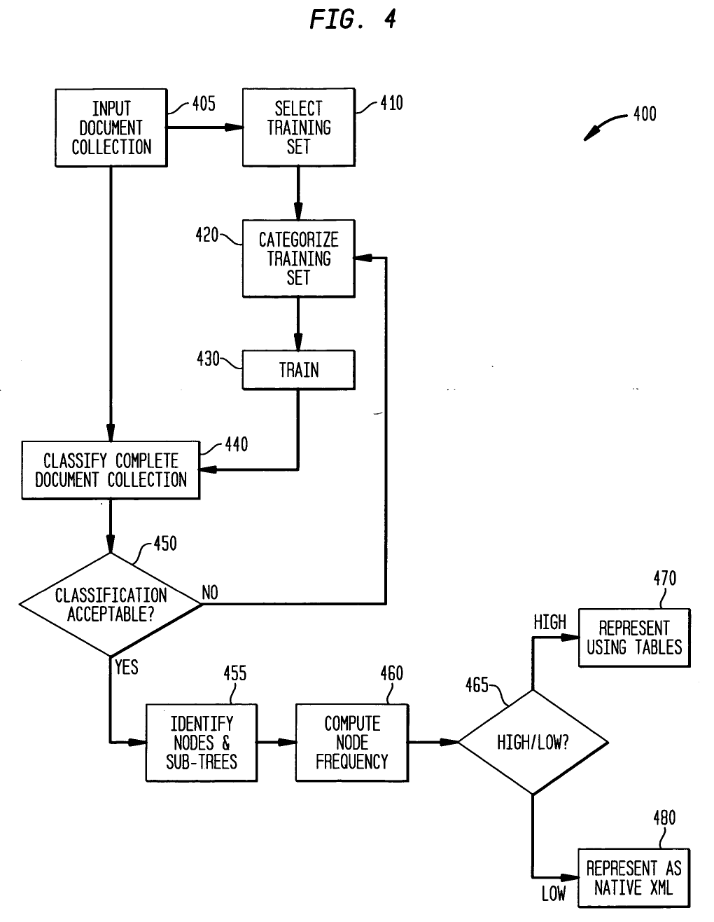

The step 290 of performing a node optimality analysis (also represented by step 120 of FIG. 1) is now described in more detail with reference to FIG. 4. In that step, it is decided whether a particular node and its sub-tree merit a tabular storage or should it be stored as a blob or an XML file.

Since a DTD is simply a grammar, it simply specifies what is valid and what is not. A DTD does not establish how often a part of the grammar is used. In other words, a DTD does not reveal whether one part of a DTD is represented more frequently in a collection of documents than other parts. That characteristic, however, is a very relevant issue in the archiving of information.

Normally DTDs are created with a certain application in mind. The documents that belong to that application often may be classified to a certain predominant set of classes. Further analysis often reveals that there are some parts of the DTD that are frequently used and other parts that are rarely being used. Should the archival system be used for querying, it is natural to expect that the nodes and the associated sub-trees that are most frequent will also be the subject of most of the queries.

Therefore, for every possible node formed in the document collection, the probability of its presence must be estimated. If that probability is high enough, it will be necessary to create a tabular structure for that node; if not, the node can be stored as a data element or as a XML node directly.

Returning to FIG. 4, there is shown a detailed sequence of steps for node optimality analysis according to the invention. The first step is to look at the documents 405 present and choose a set of representative documents (step 410). The selected documents are classified (step 420) into a set of categories.

Using the above as a test set, a neural network or a Bayesian classifier is trained (step 420). The remaining document collection is then classified (step 440). The classification is then evaluated, and the steps 420-440 are repeated until the classification is acceptable (decision 450).

Each of the nodes and corresponding sub-trees are identified (step 455) for each document class, and the most important node and sub trees are identified by computing frequencies for those nodes (step 460). Those nodes having a high frequency (step 465) are mapped to table schemas (step 470) for the relational database representation. The mapping is carried out using an object mapping method as described below. All other outlier nodes are represented in their native XML format (step 480). If a child node is represented via a tabular format, so is the parent, as XML documents always maintain the hierarchy.

The next step in the overall process is to map the above-identified DTD segments to objects and classes, as represented by step 130 of FIG. 1. As mentioned before, that mapping is actually an interim step that is meant to identify the tables and the relationships that they might have between them, in which case, what the primary keys and the foreign keys should be.

The mapping procedure includes the following steps. First, all elements that have children are identified. A class is next associated with those elements. If an element or attribute is of type PCDATA, then a terminal String variable is associated with it. Elements that have children are associated with the corresponding class. If an element is repeatable, then an array is associated with it. Attributes of type CDATA are associated with string classes.

Database schema creation, represented by step 140 of FIG. 1, is now described. In this final step in the database creation process, the mapping process is completed by going from the object schema to the table description. The database schema creation process uses the schema description generated from the classes as well as the inference from the XML files to characterize the column elements.

The steps of the database schema creation process are as follows. First, a table is associated with each class unless the class represents a table subpart. If there is a child that in itself is a class, that creates a foreign key. If a class is a child of another class, that defines a primary key for that class.

All string classes are mapped to columns. If a class is a class and a table row, it is mapped to a simple row. If any class is an array, it is mapped to a table.

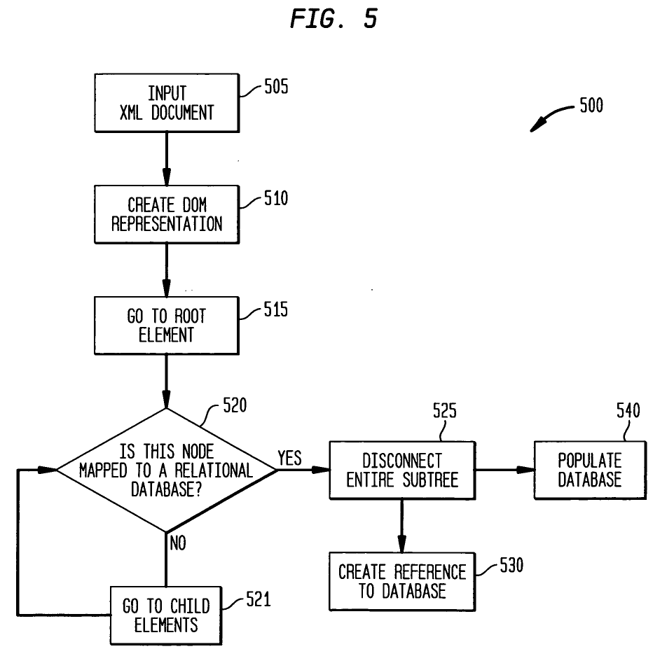

The process of database population will now be discussed with reference to FIG. 5. That process populates both the native XML part of the database as well as the relational database part of it. The step is important because it is here that the documents are broken up and segments that should be stored in a relational database are taken out and stored there. At the same time, documents that are stored as regular XML documents carry a reference to the table where the rest is continued. The steps in this process are as follows:

First, a DOM representation is created (step 510) for the input XML document 505. For each node beginning with the root node (step 515) and proceeding through the child nodes (step 521), check to see in the DTD if this node is to be mapped to a relational database table (decision block 520). If that is the case, the node is disconnected (step 525) and a reference is created to the appropriate database table (step 530).

The data is populated (step 540) in the severed node to the appropriate database tables following the schema defined earlier. The process continues through all child elements.

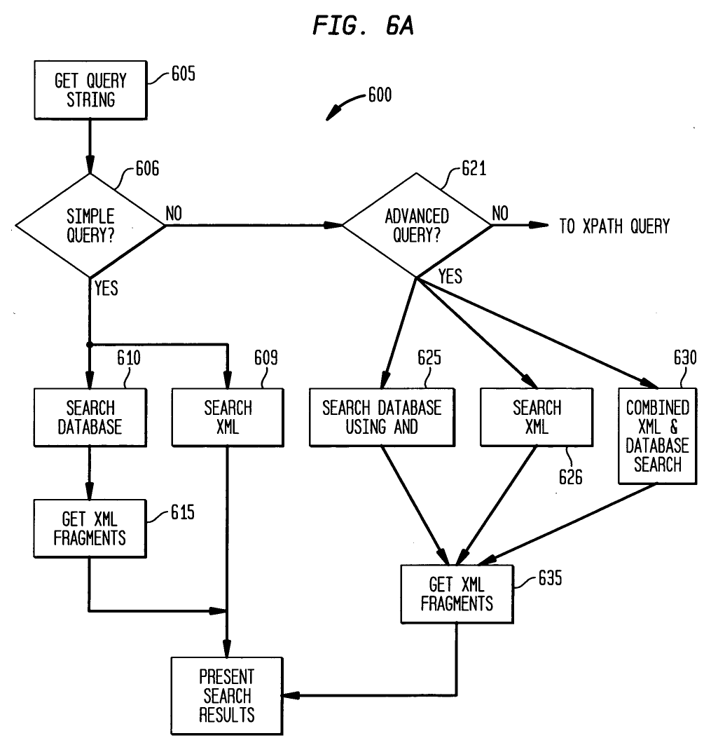

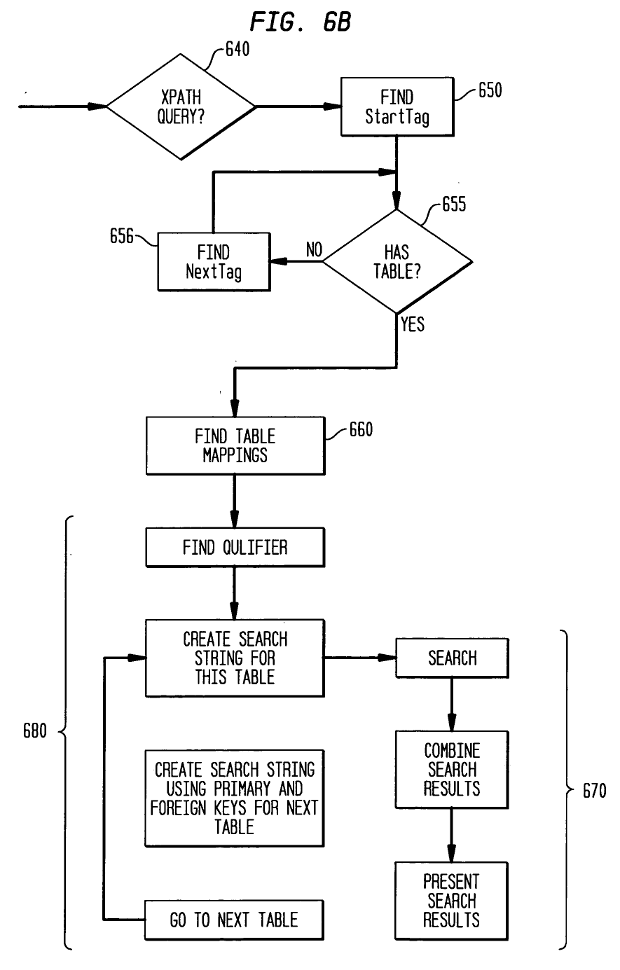

The overall step of query formulation will now be described with reference to FIGS. 6a & 6b. That step takes a normal query and maps it to a query that is suitable to the system. XML is a hierarchical language and lends itself to a very structured grammar for making queries. To assure that the system generated above works effectively against such queries, the objective is to map the queries to SQL statements where appropriate that would then be used to extract the appropriate entry from the document.

There are several ways to query an XML document. In the present disclosure, the most common standard, Xpath, is mapped to work with above-described database. Referring to FIGS. 6a & 6b, the main steps in the process are as follows:

The type of query is initially identified (step 605). If the query is a simple text query for a keyword (decision 606), map it to a simple database query using the SELECT and WHERE clause using OR to join searches from all the columns of all the tables (step 610). In addition to searching the database part of the system, a text search is also performed for the rest of the system where the XML documents are stored (step 609).

If there is a match in the database part of the system, the whole sub-node of the XML tree is extracted (step 615) up to the match point. On the other hand, if the match is in the raw XML part of the system, the necessary node is already available.

If the search is an advanced search (decision 621) where multiple fields from different columns are specified, the search is mapped to a database search using a SELECT and WHERE clause using AND to find the intersection of all searches (step 625). As above, that addresses only the database mapped part of the system, and in addition to that search, a text search is also performed for the rest of the system where the XML documents are stored (step 626).

It is also possible that the words match different parts of the system; i.e., some of the words are in the raw XML part and some in the database part. All the three possibilities are considered; i.e., the match could be entirely in the XML part (step 626), or entirely in the database (step 625) or could require a mixed search (step 630). In any case, all the corresponding nodes are selected (step 635) in exactly the same way as in the previous case.

In addition to the simple query 606 and advanced query 621, an important search in the query formulation is that using an XPath statement 640. Those statements can either start at the root and follow all the way to specify the value of an element or an attribute or might just start at some point in the tree and specify the value of an element or attribute somewhere in the sub-tree. Thus the first step 650 is to identify the location of the start tag in the query. For that start tag it is determined (step 655) whether it belongs to the raw XML part of the system or some table in the database. The same determination is made for each element that is specified in the query string. If the whole segment is part of the XML segment of the system (step 656), then the sub-trees of all the XML documents are searched and identified. That collection is the result of the search.

If at some point it is observed from the DTD that one of the elements belongs to the database part of the system, then that part of the query is broken up. A resulting XPath query is entirely related to the database part of the system.

That part of the query is mapped (step 660) to an SQL string. The DTD is then revisited to map that particular hierarchy to the table to determine which table to look for (sequence 680). Once the table is known, it is searched (sequence 670) for the corresponding element and attribute values that are specified. The actual search is done by converting the XPath query substring as an advanced search using SQL as described above.

That described system and method provides a way to optimally archive and query XML documents. Since only those portions of the XML documents that merit a tabular description are mapped, there is maximum use of the tables and the table design is optimal in the sense of the metric used to classify documents.

On the other hand, all the advantages of a relational database are preserved, such as quick querying for the data-centric part of the documents that are often stored in the database part of the system.

Round-tripping, i.e., extracting whole documents or subsections thereof, is possible because at no point is the hierarchical structure of the data lost in the transformation. That results in a faster query time both, for data-centric and document-centric data, as in either case the segments of the system that store the data are appropriately suited for that type of data.

The above-described technique of the invention provides a mechanism to analyze the importance of a node and the associated sub-tree in a structured document environment.

Managing Document Updating

While the above-mentioned technique provides an efficient way to use XML as a data storage mechanism on the Web, it is also important that that data be effectively managed. The data must, for example, be updated, deleted or replaced as deemed necessary. Huge volumes of data necessitate the automation of those processes. In the following discussion, the above technique is supplemented to provide for the updating of data stored as XML files.

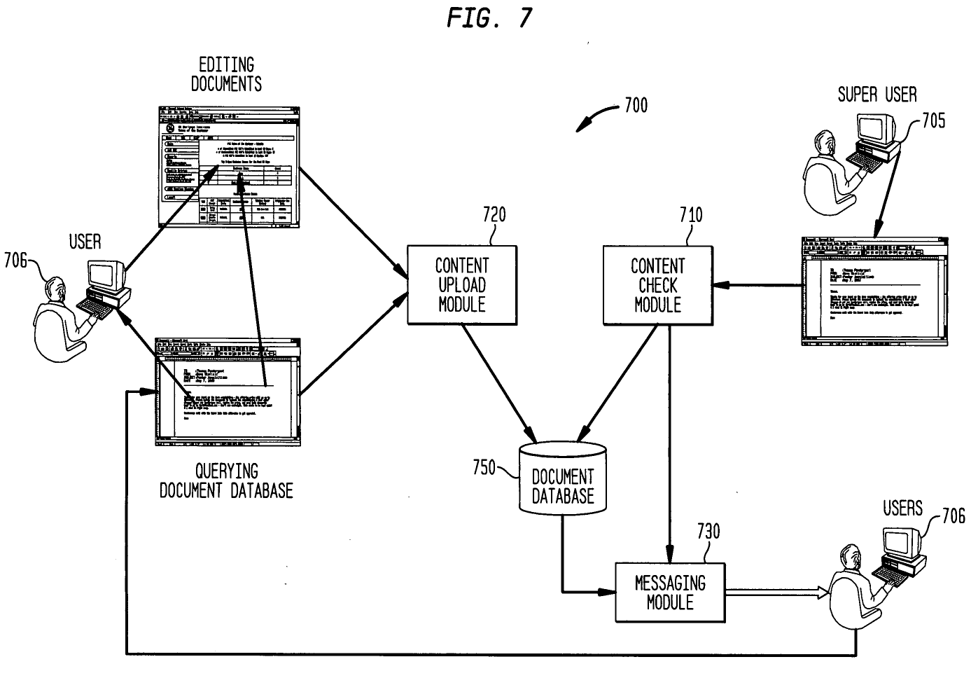

A schematic diagram showing an overview of the environment 700 for updating data stored as XML documents in a document database 750 is shown in FIG. 7. The content check module 710 can be triggered either by the super-user 705 or it could be triggered automatically as designated by an administrator. The users 706 are the owners of individual documents within the environment.

The content upload module 720 utilizes a DTD (not shown) created to capture the structure in which the documents are organized. For any application or an organization, that DTD must be written to encode the underlying structure.

For example, an organization frequently consists of a number of departments, which each consist of certain specialties, which, in turn, may consist of certain other sub-specialties and so on. Each one of those specialties or sub-specialties and each department may be associated with several documents that describe different aspects of it. The DTD should also include appropriate attributes to indicate characteristics such as the document owners, document class, and document applications. In that way, other views of the documents can be created.

The DTD is mapped to a relational database 750 where the XML data resides. The relational database 750 with the DTD is used to trigger rules for updating the data.

The content check module 710 uses rules in identifying documents for update. Wherever applicable, those rules must be mapped to a rules table in the database 750 to facilitate maintenance and updating of the rules.

The content check module 710 also includes a rules engine that reads the rules and acts on them whenever there is a need. That module will also determine whether a certain document is rich enough; i.e., whether the document carries the necessary information.

A messaging module 730 sends reminders to the document owners or users 706 to take necessary actions.

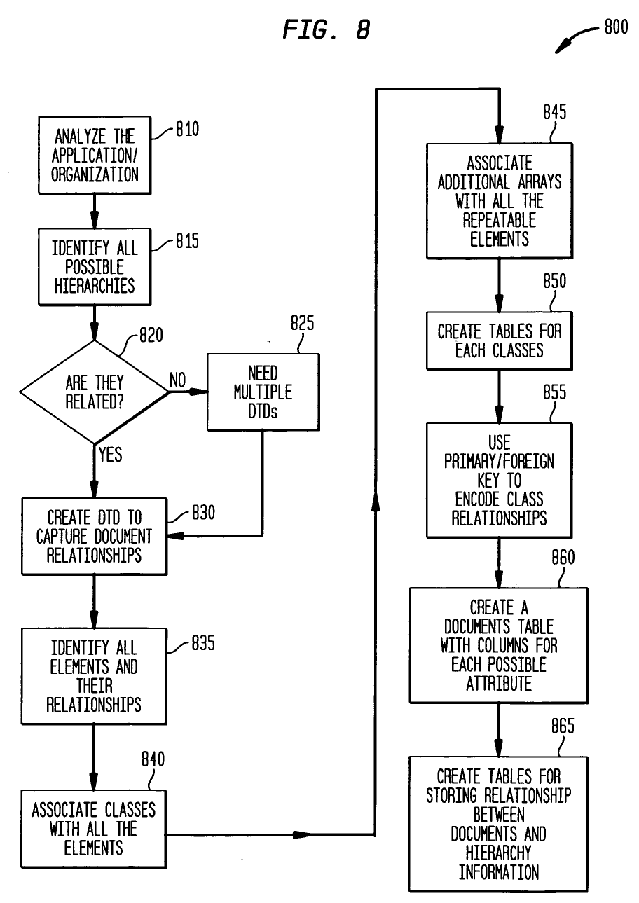

The process 800 of creating a DTD and mapping the DTD to the database will now be described with reference to FIG. 8. Initially, the application or organization must be analyzed (step 810) in order to understand it and to identify the documents that must be maintained by the system. The hierarchy of documents in the associated system is next identified (step 815). If there are more than one hierarchies present, the most dominant hierarchy must be identified, and links or associations between the dominant hierarchy and the others must be found. If no such links exist (decision 820), the user might consider creating (step 825) one or more additional DTDs for the orphan hierarchy(ies).

Once the hierarchy is identified, appropriate attributes must to be created as needed for triggering the rules. Attributes also provide the link that associates the different hierarchies that exist in the system if a single DTD is created.

The DTD is next created (step 830) to capture all document relationships. The end nodes of the DTD are the documents themselves. Once the DTD is created, all elements and their relationships are identified (step 835). A class is associated (step 840) with those nodes that have children. Elements that have children are associated with the corresponding class.

If an element is repeatable, an array is associated (step 845) with it. For each of the classes, a table is created (step 850) and associated with each class unless the class represents a table subpart.

A primary/foreign key scheme is used (step 855) to encode relationships among classes. If a child is a class in itself, that creates a foreign key. If a class is a child of another class, then a primary key is defined for that class.

A documents table is created (step 860) containing all the document names, file locations, etc. For each possible attribute of those documents a separate column is created to store the attribute values. In a separate table or in the same table, relationships between documents and hierarchy information are stored (step 865).

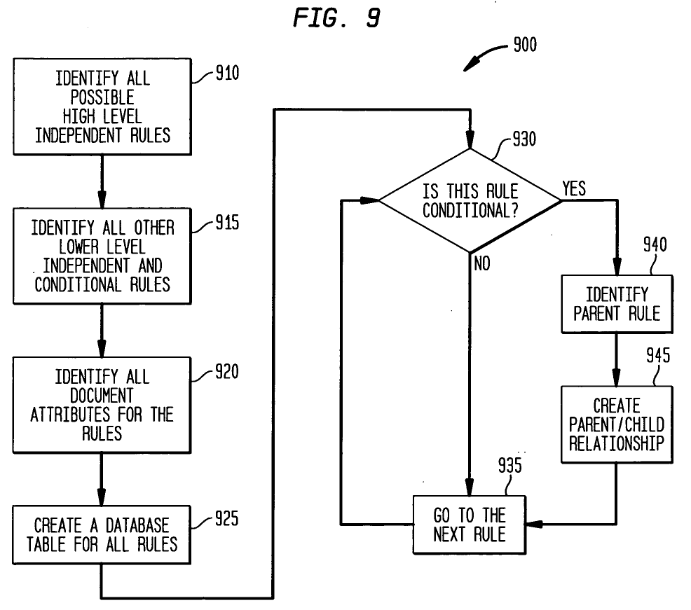

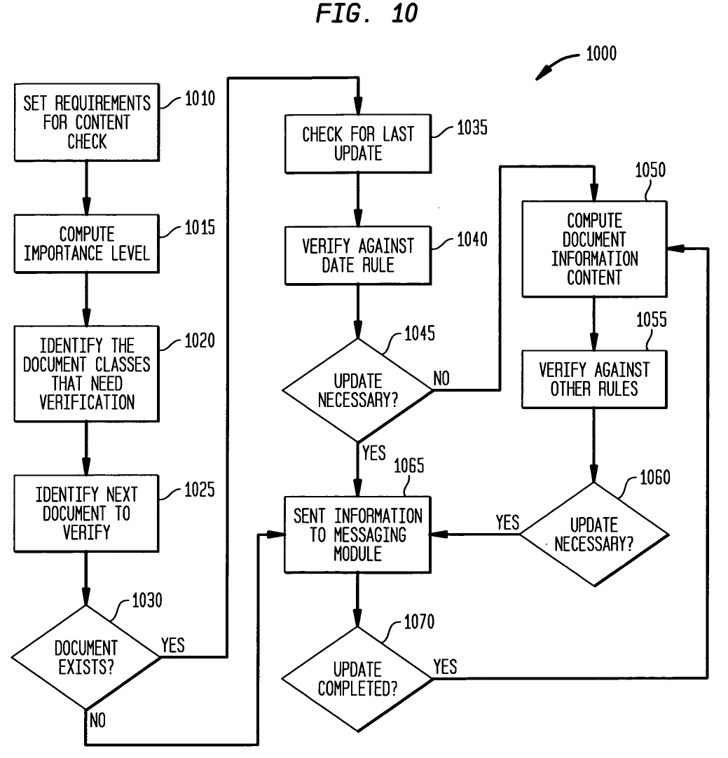

The creation of the rules database will now be described with reference to FIG. 9. As discussed above, document checking for either the content or validity or usage is to be determined by the rules. The rules must be implemented in a very flexible manner so that over time they can be changed and reformulated. Further, some rules may be more important than others, and some may be conditional; i.e., rules that trigger only when certain other rules either trigger or don't trigger. It is also important to identify the class of documents to which the rules apply.

In a process 900 for creating the rules database, all possible high-level, independent rules are initially identified (step 910). The second, third and lower tier rules, both independent and conditional, are also identified (step 915). If the lower tier rule is conditional, the parent rule is identified.

All documents attributes against which the rules will apply are then identified (step 920). A database table is then created (step 925) to store the rules and the relationships between them. Columns are created for all the attributes identified in step 920.

The database is then populated with the rules, identifying the class of documents against which the rules will apply. For each rule (step 935), it is determined whether the rule is conditional (decision 930). If so, the parent rule is identified (step 940) and a relationship is created between the parent rule and child rule (step 945).

Rules may be as simple as examining a time period elapsed since last update. Conversely, rule may be very complicated and may actually involve computing the information content.

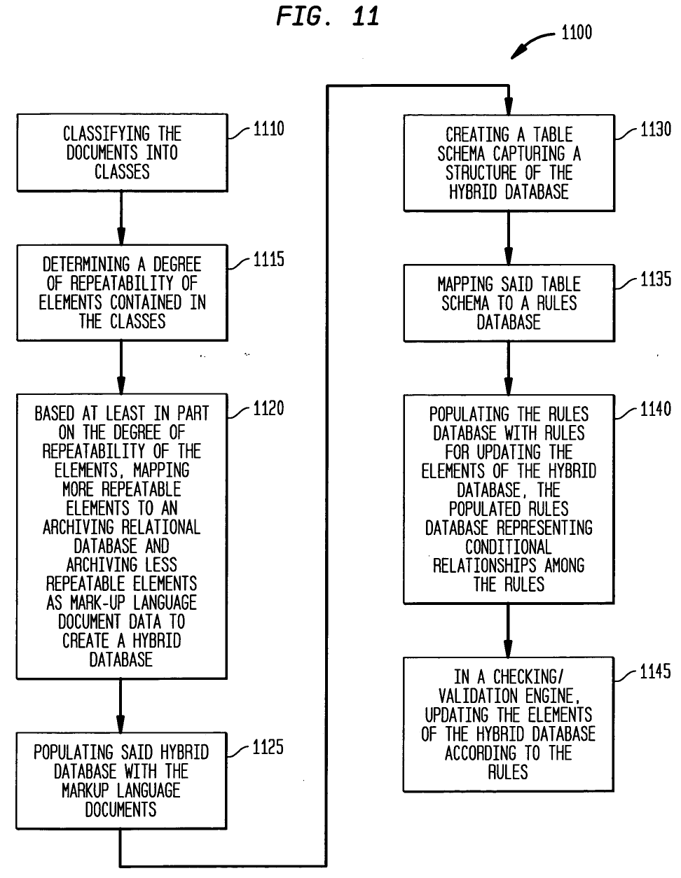

A method 1000 performed by the document checking/validation engine according to the invention will now be described with reference to FIG. 10. Once design of the document update system is complete, the document checking/validation engine actually performs most of the substantive tasks executed by the system. Document checking is based on rule verification and is done in a very methodical manner.

As an initial step performed by the document checking/validation engine, requirements are set (step 1010) for when the content check module is triggered for use. It could be either because of a certain time such as start of a day, week or a month, or it could be because of a certain event has taken place or it could simply be manual.

An importance level is computed (step 1015) at which the documents must be updated. The importance level may be identified in at least two alternative ways. In one technique, the importance level may be a function of the hierarchy level at which the document is found. Alternatively, the importance level may be derived from the attribute definition. For instance an overview document is certainly more important than a document that describes the details for a certain department or specialty.

The document classes that need verification are then identified (step 1020), and the next document is identified for verification (step 1025). Once a document is selected, the database is checked to see if the document exists (decision 1030), and, if so, when it was last updated (step 1035). If a date rule exists for that document in terms of time since the last update, the system checks (step 1040) whether the rule requires an update.

If the date rule does not require an update (decision 1045), then the document information content is measured (step 1050). There are several alternative ways to compute document information content. In one example, the document is parsed to compute the number of nodes, leaf nodes, number of images, paragraphs and titles and other such attributes. Another technique for computing document information content is to use information theoretic methods to find out how much of an intrinsic variation exists in the document. A document may have several paragraphs that could probably be single lines or even empty.

Once the document information content is computed, the rules database is accessed to verify (step 1055) whether, for the document class under consideration, whether the document needs an update.

If an update is necessary (decision 1060), information regarding the document owners is sent (step 1065) to the messaging module. Information regarding the reason for an update is also communicated.

If a document is updated (step 1070) and uploaded back to the system, document information content is computed (step 1050) as described above. If the document information content is inadequate based on the appropriate rule, then a communication is sent back to the document owners regarding possible re-updating requirements.

The messaging module described above with reference to step 1065 is a module that informs the document owners regarding possible update requirements. In addition, the messaging module communicates to the document owners reasons that an update is needed, and deadlines that must be followed to update the system in a timely manner. If more than one document requiring updating belongs to the same owner, the information is compiled together before transmission to the owner.

The above-described document updating system provides ways to easily update and maintain a large document collection on a regular basis without too much manual intervention. Organizational information regarding documents is stored in a DTD that is then mapped to a database for use within an internet capable framework.

The system is versatile and can cope with a variety of document verification and update rules. The rules database is used to store rules that can be changed over time to reflect the changing requirements of the organization. The document checking module can validate a document against a variety of rules that range from the most obvious to more sophisticated information-theoretic rules that measure document information.

Incoming documents either newly created or updated are validated to assure that proper information is present before being published. The system can be set to run on its own with very limited manual effort.

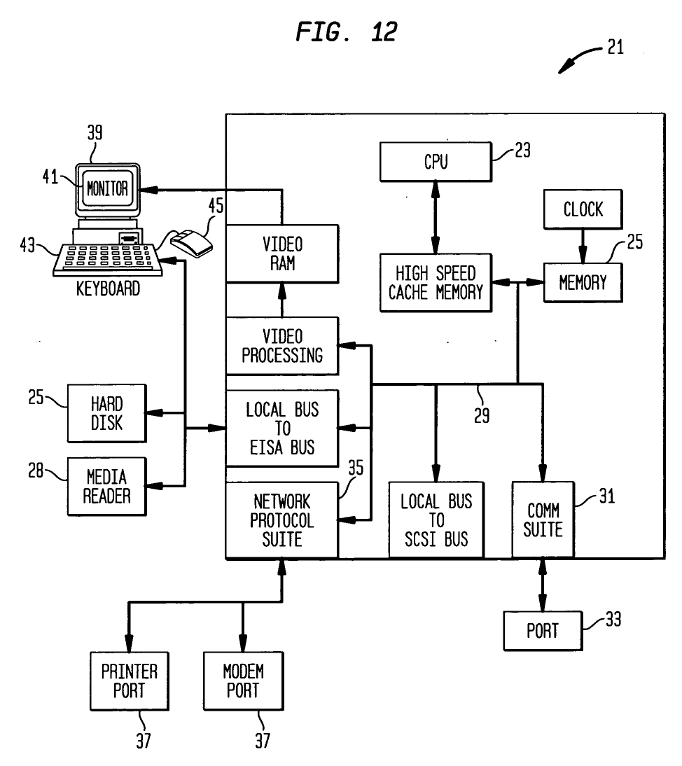

A flow chart showing an overview of a method 1100 for managing mark-up language documents according to one embodiment of the invention will now be described with reference to FIG. 11. In the method, documents are initially classified (step 1110) into classes. A degree of repeatability of elements contained in the class is then determined (step 1115). Based at least in part on the degree of repeatability of the elements, more repeatable elements are mapped to an archiving relational database, and less repeatable elements are archived as mark-up language document data, to create a hybrid database (step 1120).

The hybrid database is then populated (step 1125) with the markup language documents, and a table schema capturing a structure of the hybrid database is created (step 1130). The table schema is mapped (step 1135) to a rules database.

The rules database is then populated (step 1140) with rules for updating the elements of the hybrid database. The populated rules database represents conditional relationships among the rules. In a checking/validation engine, the elements of the hybrid database are updated (step 1145) according to the rules.

The foregoing Detailed Description is to be understood as being in every respect illustrative and exemplary, but not restrictive, and the scope of the invention disclosed herein is not to be determined from the Description of the Invention, but rather from the Claims as interpreted according to the full breadth permitted by the patent laws. For example, while the technique is described primarily for use in connection with the storage and retrieval of data stored as XML documents, those skilled in the art will understand that the technique may be used as well in connection with data stored using other mark-up languages and other extensible languages. It is to be understood that the embodiments shown and described herein are only illustrative of the principles of the present invention and that various modifications may be implemented by those skilled in the art without departing from the scope and spirit of the invention.

What is claimed is:

1. A method for managing mark-up language documents, the method comprising the steps of:
classifying the documents into classes;
determining a degree of repeatability of elements contained in the classes;
based at least in part on the degree of repeatability of the elements, mapping more repeatable elements to an archiving relational database and archiving less repeatable elements as mark-up language document data to create a hybrid database;
populating said hybrid database with the markup language documents;
creating a table schema capturing a structure of the hybrid database;
mapping said table schema to a rules database;
populating the rules database with rules for updating the elements of the hybrid database, the populated rules database representing conditional relationships among the rules; and
in a checking/validation engine, updating the elements of the hybrid database according to the rules.

2. The method of claim 1, wherein the step of classifying the documents into classes further comprises:
analyzing a tree structure of at least one DTD defining the documents.

3. The method of claim 2, wherein the step of classifying the documents into classes further comprises:
selecting a test set of documents representative of the mark-up language documents;
training a learning network using the test set;
classifying a remainder of the mark-up language documents using the trained learning network; and
repeating the selecting, training and classifying steps to improve the classification.

4. The method of claim 1,
further comprising, for each class, the step of identifying important sub-trees of the class based on sub-tree size; and
wherein the step of determining a degree of repeatability of elements contained in the classes further comprises determining that a node not in an important sub-tree is one of said less repeatable elements.

5. The method of claim 4, wherein the step of determining a degree of repeatability of elements contained in the class further comprises, for each important sub-tree, the steps of:
associating those elements of the sub-tree having children, with a class;
if one of said elements having children is of type PCDATA, associating a terminal string variable with it; and
if an element is repeatable, associating an array with it.

6. The method of claim 5, wherein the step of mapping more repeatable elements to the archiving relational database and archiving less repeatable elements as mark-up language document data to create a hybrid database further comprises, for each said class associated with a sub-tree having children, the steps of:
associating a table with the class unless the class represents a table subpart;
defining a foreign key from each child that is in itself a class;
defining a primary key from each class that is a child of another class;
mapping all said string classes to columns;
mapping all classes that are table rows to simple rows; and
mapping all classes that are arrays to a table.

7. The method of claim 1, wherein the step of populating said hybrid database with the markup language documents further comprises, for each mark-up language document, the steps of:
creating a document object model (DOM) representation;
for each node of the DOM representing an element to be mapped to a table in the archiving relational database, disconnecting the node and creating a reference to said table; and
populating tables in the archiving relational database with data in the disconnected node.

8. The method of claim 1, wherein the step of creating a table schema capturing a structure of the hybrid database comprises the steps of:
creating attributes for triggering rules and for linking hierarchies in the table schema;
creating the table schema, wherein end nodes of said table schema are the mark-up language documents;
associating classes with all elements; and
encoding class relationships using primary and foreign keys.

9. The method of claim 1, wherein the step of populating the rules database with rules for updating the elements of the hybrid database comprises the steps of:
identifying all high level rules;
identifying conditional rules and associated parent rules;
associating document attributes with high level rules and conditional rules to which the attributes apply;
identifying classes against which said high level and conditional rules apply; and
populating the rules database with rules and relationships of the rules with other rules, documents attributes and document classes.

10. The method of claim 1, wherein the step of updating the elements of the hybrid database according to the rules comprises the steps of:
triggering a document update of a subject document according to a rule;
checking whether the subject document exists, and if not, determining that an update is necessary;
computing document content information of the subject document;
using the computed document content information, checking whether the subject document is current according to the rule, and if not, determining that an update is necessary; and
if an update is necessary, transmitting a notification to a document owner.

11. The method of claim 10, wherein the step of computing document content information comprises computing a number of nodes of the document.

12. The method of claim 10, wherein the step of computing document content information comprises using an information theoretic technique of measuring intrinsic variation in the document.

13. A computer program product comprising a computer readable recording medium having recorded thereon a computer program comprising code means for, when executed on a computer, instructing said computer to control steps in a method for managing mark-up language documents, the method comprising the steps of:
classifying the documents into classes;
determining a degree of repeatability of elements contained in the classes;
based at least in part on the degree of repeatability of the elements, mapping more repeatable elements to an archiving relational database and archiving less repeatable elements as mark-up language document data to create a hybrid database;
populating said hybrid database with the markup language documents;
creating a table schema capturing a structure of the hybrid database;
mapping said table schema to a rules database;
populating the rules database with rules for updating the elements of the hybrid database, the populated rules database representing conditional relationships among the rules; and
in a checking/validation engine, updating the elements of the hybrid database according to the rules.

14. The computer program product of claim 13, wherein the step of classifying the documents into classes further comprises:
analyzing a tree structure of at least one DTD defining the documents.

15. The computer program product of claim 14, wherein the step of classifying the documents into classes further comprises:
selecting a test set of documents representative of the mark-up language documents;
training a learning network using the test set;
classifying a remainder of the mark-up language documents using the trained learning network; and
repeating the selecting, training and classifying steps to improve the classification.

16. The computer program product of claim 13,
further comprising, for each class, the step of identifying important sub-trees of the class based on sub-tree size; and
wherein the step of determining a degree of repeatability of elements contained in the classes further comprises determining that a node not in an important sub-tree is one of said less repeatable elements.

17. The computer program product of claim 16, wherein the step of determining a degree of repeatability of elements contained in the class further comprises, for each important sub-tree, the steps of:
associating those elements of the sub-tree having children, with a class;
if one of said elements having children is of type PCDATA, associating a terminal string variable with it;
if an element is repeatable, associating an array with it.

18. The computer program product of claim 17, wherein the step of mapping more repeatable elements to the archiving relational database and archiving less repeatable elements as mark-up language document data to create a hybrid database further comprises, for each said class associated with a sub-tree having children, the steps of:
associating a table with the class unless the class represents a table subpart;
defining a foreign key from each child that is in itself a class;
defining a primary key from each class that is a child of another class;
mapping all said string classes to columns;
mapping all classes that are table rows to simple rows; and
mapping all classes that are arrays to a table.

19. The computer program product of claim 13, wherein the step of populating said hybrid database with the markup language documents further comprises, for each mark-up language document, the steps of:
creating a document object model (DOM) representation;
for each node of the DOM representing an element to be mapped to a table in the archiving relational database, disconnecting the node and creating a reference to said table; and
populating tables in the archiving relational database with data in the disconnected node.

20. The computer program product of claim 13, wherein the step of creating a table schema capturing a structure of the hybrid database comprises the steps of:
creating attributes for triggering rules and for linking hierarchies in the table schema;
creating the table schema, wherein end nodes of said table schema are the mark-up language documents;
associating classes with all elements; and
encoding class relationships using primary and foreign keys.

21. The computer program product of claim 13, wherein the step of populating the rules database with rules for updating the elements of the hybrid database comprises the steps of:
identifying all high level rules;
identifying conditional rules and associated parent rules;
associating document attributes with high level rules and conditional rules to which the attributes apply;
identifying classes against which said high level and conditional rules apply; and
populating the rules database with rules and relationships of the rules with other rules, documents attributes and document classes.

22. The computer program product of claim 13, wherein the step of updating the elements of the hybrid database according to the rules comprises the steps of:
triggering a document update of a subject document according to a rule;
checking whether the subject document exists, and if not, determining that an update is necessary;
computing document content information of the subject document;
using the computed document content information, checking whether the subject document is current according to the rule, and if not, determining that an update is necessary; and
if an update is necessary, transmitting a notification to a document owner.

23. The computer program product of claim 22, wherein the step of computing document content information comprises computing a number of nodes of the document.

24. The computer program product of claim 22, wherein the step of computing document content information comprises using an information theoretic technique of measuring intrinsic variation in the document.
